(19) United States
(12) Patent Application Publication
(10) Pub. No.: US 2010/0253786 A1
(43) Pub. Date: Oct. 7, 2010

(54) IMAGE FILE GENERATING DEVICE AND IMAGE REPRODUCING DEVICE

(75) Inventor: Tetsuya KONISHI, Machida-shi (JP)

Correspondence Address: OLIFF & BERRIDGE, PLC, P.O. BOX 320850, ALEXANDRIA, VA, 22320-4850, US

(73) Assignee: NIKON CORPORATION, TOKYO (JP)

(21) Appl. No.: 12/751,400

(22) Filed: Mar. 31, 2010

(30) Foreign Application Priority Data
Apr. 1, 2009 (JP) 2009-089018

(51) Int. Cl. H04N 5/225; H04N 5/228

(52) U.S. Cl. 348/207.1; 348/222.1; 348/E05.031; 348/E05.024

(57) ABSTRACT

An image file generating device generates a still image file in which a first frame image, a second frame image and a third frame image are associated with one another, with the first frame image obtained according to a command; the second frame image being an image of an earlier point in time than the first frame image, and containing at least a common main subject with the first frame image; and the third frame image being an image of an earlier point in time than the second frame image, and containing at least the main subject.

### INCORPORATION BY REFERENCE

The disclosure of the following priority application is herein incorporated by reference:

Japanese Patent Application No. 2009-089018 filed Apr. 1, 2009,

### BACKGROUND OF THE INVENTION

1. Field of the Invention

The present invention relates to an image file generating device, and an image file reproducing device for reproducing the image file.

2. Description of Related Art

Japanese Laid-Open Patent Publication No. 2005-25715 discloses a technology of creating a short film like a movie from still pictures.

There is a demand to know how a subject was moving, by looking at the still pictures rather than the short film. The still pictures, which capture moments of the movement of the subject, are lacking in information that makes an observer grasp the direction and speed of the movement. Thus, even through observation of the still pictures, it is difficult to know the direction of the movement of the subject.

### SUMMARY OF THE INVENTION

An image file generating device according to a first aspect of the present invention generates a still image file in which a first frame image, a second frame image and a third frame image are associated with one another, wherein: the first frame image is obtained according to a command; the second frame image is an image of an earlier point in time than the first frame image, the second frame image containing at least a common main subject with the first frame image; and the third frame image is an image of an earlier point in time than the second frame image, the third frame image containing at least the main subject.

According to a second aspect of the present invention, in the image file generating device according to the first aspect, it is preferable that the main is a moving subject.

According to a third aspect of the present invention, in the image file generating device according to the first aspect, it is preferable that the second frame image and the third frame image have a lower resolution than the first frame image.

According to a fourth aspect of the present invention, in the image file generating device according to the first aspect, blurring may be applied to main subject regions of the second frame image and the third frame image which contain the main subject.

According to a fifth aspect of the present invention, in the image file generating device according to the first aspect, background regions of the second frame image and the third frame image which exclude main subject regions containing the main subject may be replaced by a single-color image.

An image reproducing device, according to a sixth aspect of the present invention, that reproduces a still image file in which a first frame image to be reproduced, a second frame image that is an image of an earlier point in time than the first frame image and contains at least a common main subject with the first frame image, and a third frame image that is an image of an earlier point in time than the second frame image and contains at least the main subject are associated with one another, wherein: the third frame image is displayed on a display device according to a reproduction command; the second frame image is displayed on the display device so as to replace the third frame image, when a predetermined time elapses after display of the third frame image; the first frame image is displayed on the display device so as to replace the second frame image, when a predetermined time elapses after display of the second frame image; and the displayed first frame image is kept displayed.

According to a seventh aspect of the present invention, in the image reproducing device according to the sixth aspect, it is preferable that the main subject is a moving subject.

According to a eighth aspect of the present invention, in the image reproducing device according to the sixth aspect, it is preferable that the second frame image and the third frame image have a lower resolution than the first frame image.

According to a ninth aspect of the present invention, in the image reproducing device according to the sixth aspect, blurring may be applied to main subject regions of the second frame image and the third frame image which contain the main subject.

According to a tenth aspect of the present invention, in the image reproducing device according to the sixth aspect, background regions of the second frame image and the third frame image which exclude main subject regions containing the main subject may be replaced by a single-color image.

A file generating device according to a eleventh aspect comprises: an image obtaining unit that obtains a first frame image, a second frame image and a third frame image; and a control unit that generates a file in which the first frame image, the second frame image and the third frame image are associated with one another, wherein: the first frame image is obtained according to a command; the second frame image is an image of an earlier point in time than the first frame image, and contains at least a common main subject with the first frame image; and the third frame image is an image of an earlier point in time than the second frame image, and contains at least the main subject.

According to a twelfth aspect of the present invention, in the file generating device according to the eleventh aspect, the control unit creates a single still image file in which the first frame image, the second frame image and the third frame image are stored, as the file.

According to a thirteenth aspect of the present invention, in the file generating device according to the eleventh aspect, the control unit creates a management file containing information for associating the first frame image, the second frame image and the third frame image with one another, as the file.

### BRIEF DESCRIPTION OF THE DRAWINGS

FIG. 1 is a view explaining an electronic camera system according to one embodiment of the invention.

FIG. 2 is a block diagram explaining the construction of a principal part of an electronic camera.

FIG. 3 is a flowchart explaining the flow of a photographing mode process.

FIG. 4 is a flowchart explaining the flow of an effect reproducing process.

FIG. 5 is a flowchart explaining the flow of an effect reproduction file generating process.

FIG. 6 is a block diagram explaining the construction of a principal part of a PC.

### DESCRIPTION OF PREFERRED EMBODIMENTS

An embodiment of the invention will be described with reference to the drawings.

### File Reproducing Device

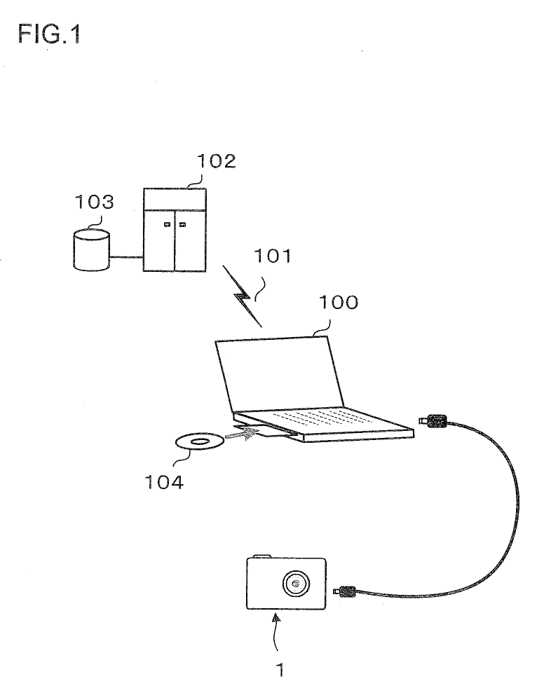

FIG. 1 is a view explaining an electronic camera system according to one embodiment of the invention. The electronic camera system consists of an electronic camera 1 and a personal computer (which will be called “PC”) 100. By loading a file reproduction program into the PC 100, and executing the program, the PC 100 is used as a file reproducing device. The loading of the program into the PC 100 may be implemented by setting a recording medium 104 that stores the program in the PC 100, or transmitting the program to the PC 100 via a communication line or network 101.

To transmit the program via the communication line 101, the program is stored on a hard disk drive 103, or the like, of a server (computer) 102 connected to the communication line 101. The file reproduction program may be supplied in various forms of computer program products, for example, may be provided through the recording medium 104 or the communication line 101. The PC 100 consists of a CPU (not shown) and its peripheral circuit (not shown), and executes programs installed therein.

The PC 100 is configured to be able to communicate with the electronic camera 1. The communication between the electronic camera I and the PC 100 may be wire communication using a cable as shown in FIG. 1, or may be radio communication or wireless communication via radio terminals that are not illustrated.

### Electronic Camera

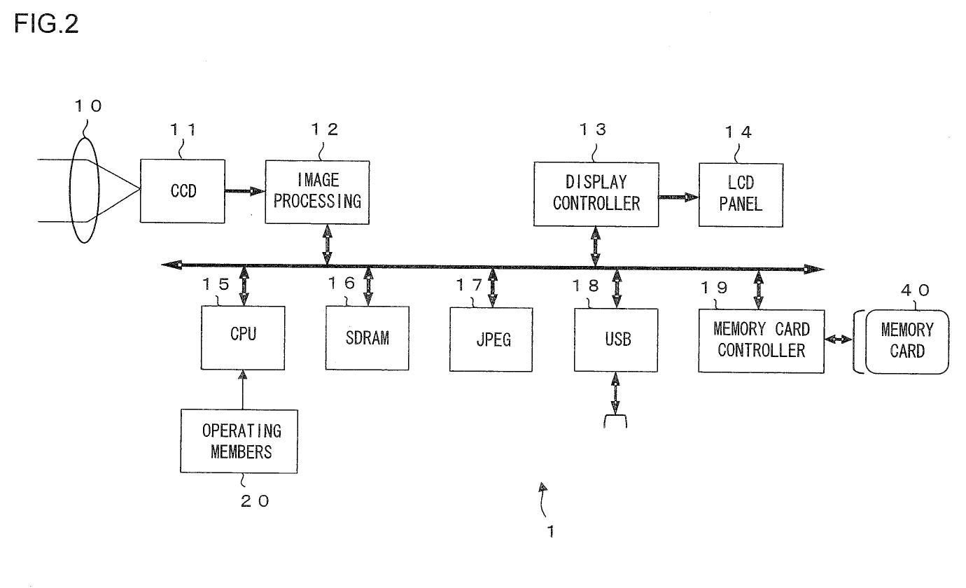

The electronic camera 1 will be described in detail. The electronic camera 1 is arranged to be switchable between a photographing mode and a reproduction or playback mode. The photographing mode is an operating mode for capturing an image of a subject, and recording data of the captured image, as an image file, onto a recording medium (reference numeral 40 in FIG. 2) in the form of, for example, a memory card. In this embodiment, in addition to the image captured according to a photo-shooting command, images captured before generation of the shooting command are also recorded on the recording medium 40. Generation and recording of image files will be described in detail later.

The reproduction mode is a mode for reading data of a designated image file from the recording medium 40, and displaying a reproduced image or images represented by the image data, on an LCD panel (reference numeral 14 in FIG. 2).

FIG. 2 is a block diagram explaining the construction of a principal part of the electronic camera 1. In FIG. 2, an image of a subject is formed on an imaging plane of an image pickup device 11 through a taking lens 10. The image pickup device 11 consists of for example, a CCD image sensor or a CMOS image sensor. The image pickup device 11 performs photoelectric conversion on the subject image and generates an analog image signal.

The analog image signal is transmitted to an image processing circuit 12. The image processing circuit 12 performs analog signal processing, such as correlated double sampling and gain adjustment, on the analog image signal. The analog image signal that has been processed is converted into digital image data by an A/D conversion circuit (not shown). The image processing circuit 12 further performs predetermined image processing (such as color interpolation, tone conversion, edge enhancement, and white balance control) on the digital image data. The image data that has been processed is subjected to JPEG compression in a compressing/ expanding circuit 17, and is recorded into an SDRAM 16. Data that has yet to be or has been subjected to image processing and data currently under image processing are also temporarily recorded in the SDRAM 16.

A CPU 15 reads JPEG compression code from the SDRAM 16, and records the code, along with certain accompanying information (metadata), onto the recording medium 40, as an image file (JPEG file), thereby to complete a photographing process. The recording medium 40 can be inserted into and removed from the electronic camera 1 as desired. The CPU 15 records data onto the recording medium 40 and reads data recorded on the recording medium 40, via a memory card controller 19.

When operating in the reproduction mode, the CPU 15 reads an image file that includes JPEG code and is recorded on the recording medium 40, and causes the compressing/expanding circuit 17 to perform expansion processing on the image file. Further, the CPU 15 causes the image processing circuit 12 to perform resolution conversion for converting the image data to an appropriate size, and temporarily records the resulting data in the SDRAM 16. A display controller 13 reads image data from the SDRAM 16 according to a command from the CPU 15, and generates data for display, based on the image data. The LCD panel 14 provided on the back of the electronic camera 1A displays a reproduced image represented by the data for display.

In the photographing mode, the CPU 15 operates the LCD panel 14 as a viewfinder. By using data for display produced without compressing digital image data, a monitor image of a subject (live view image or through image) is displayed on the LCD panel 14.

A USB controller 18 conducts certain communications with external equipment (e.g., PC 100). The electronic camera 1 transfers image files to the external equipment via the USB controller 18. Transferring of image files may include copying and moving of the image files.

The CPU 15 controls operations of the electronic camera 1, by executing programs stored in a nonvolatile memory (not shown) incorporated therein. The CPU 15 receives signals generated from respective blocks, performs certain operations or computations, and outputs control signals based on the computation results, to the respective blocks.

Operating members 20 include a half-press switch and a full-press switch, which are placed in the ON/OFF position in accordance with an operation to press down a release button (not shown), a menu switch, and so forth. The operating members 20 send an operation signal representing each operation or manipulation, to the CPU 15.

This embodiment is characterized in an effect reproduction process; therefore, the effect reproduction process will be mainly described below. In the effect reproduction, reproduced images formed from data of a plurality of frames of images are displayed in sequence like animation, using an image file for use in effect reproduction as will be described later. For example, an image captured according to a photo-shooting command is displayed after images captured before the shooting command are displayed by using motion JPEG.

### Generation of Image File for Effect Reproduction

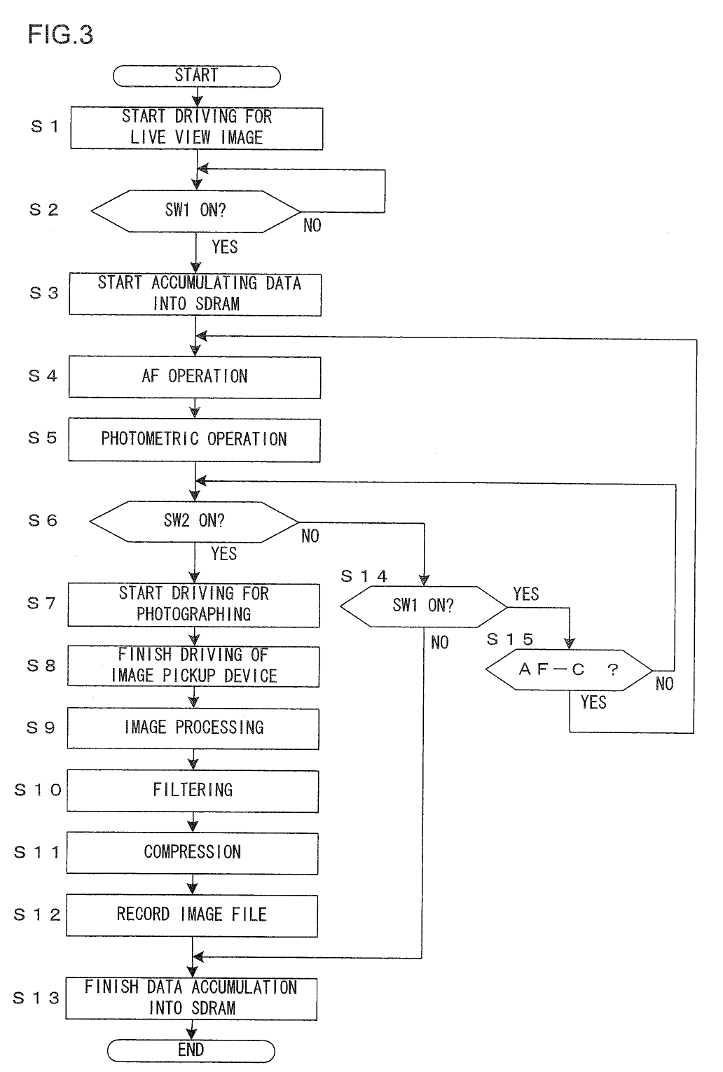

The CPU 15 of the electronic camera 1 switches its operating mode to the photographing mode when switching to the photographing mode is instructed by an operation signal from the operating members 20, and repeatedly carries out a process as illustrated in FIG. 3. FIG. 3 is a flowchart explaining the flow of the process for the photographing mode. In step S1 of FIG. 3, the CPU 15 starts driving control for live view imaging on the image pickup device 11, and proceeds to step S2. As a result, the image pickup device 11 starts acquiring live view image data. Live view images mean monitor images (images that appear on the monitor) acquired before a shooting command is generated. The CPU 15 is configured to repeat acquisition of a live view image and display of the live view image on the LCD panel 14, until a half-press switch SW1 which will be described later is operated to the ON position.

In step S2, the CPU 15 determines whether the half-press switch SW1 is placed in the ON position. The half-press switch SW1, which constitutes the operating members 20, outputs an ON signal to the CPU 15 in accordance with an operation to press down a release button (not shown). The half-press switch SW1 generates a half-press operation signal when the release button is pressed halfway down to about a half of the normal stroke, and ceases to generate the half-press operation signal when the operation to press the release button halfway down is terminated. When the CPU 15 receives the half-press operation signal from the half-press switch SW1, it makes an affirmative decision in step S2, and proceeds to step S3. When the CPU 15 receives no half-press operation signal from the half-press switch SW1, it makes a negative decision in step S2, and repeats the determining operation.

The CPU 15 starts accumulating live view image data in the SDRAM 16 in step 53, and proceeds to step S4. As a result, data of a given number of the latest frames (e.g., three frames) of live view images, out of the live view images captured at a frame rate of, for example, 30 frames/sec., is written to the SDRAM 16 over the existing data, and stored.

The CPU 15 performs a predetermined AF (autofocusing) operation in step S4, and proceeds to step S5. The CPU 15 performs a photometric operation in step S5, and proceeds to step S6. The photometric operation is to calculate a shutter speed and an aperture value, based on an image signal obtained by the image pickup device 11.

In step S6, the CPU 15 determines whether the full-press switch SW2 is placed in the ON position. The full-press switch SW2, which constitutes the operating members 20, outputs an ON signal to the CPU 15 in accordance with an operation to press down the release button (not shown). The full-press switch SW2 generates a full-press operation signal when the release button is fully pressed down to its normal stroke, and ceases to generate the full-press operation signal when the operation to press the release button down to its normal stroke is terminated. When the CPU 15 receives the full-press operation signal from the full-press switch SW2, it makes an affirmative decision in step S6, and proceeds to step S7. When the CPU 15 receives no full-press operation signal from the full-press switch SW2, it makes a negative decision in step S6, and proceeds to step S14.

In step S14, the CPU 15 determines whether the half-press switch SW1 is in the ON position. If the CPU 15 keeps receiving the half-press operation signal from the half-press switch SW1, it makes an affirmative decision in step S14, and proceeds to step S15. If the CPU 15 does not receive the half-press operation signal from the half-press switch SW1, it makes a negative decision in step S14, and proceeds to step S13.

In step S15, the CPU 15 determines an AF-servo setting content. When an AF-C mode is set as the AF servo, the CPU 15 makes an affirmative decision in step S15, and returns to step S4. The AF-C mode is a mode in which the AF (autofocusing) operation is repeatedly performed. If an AF-S mode is set as the AF servo, the CPU 15 makes a negative decision in step S15, and returns to step S6. The AF-S mode is an AF lock mode in which only one AF (autofocusing) operation is performed, and the resulting focus status is maintained. The selection of the AF servo is made in advance according to the operation of the operating members 20 by the user.

The CPU 15 proceeds to step S7 when it makes an affirmative decision in step S6 as described above. In step 57, the CPU 15 starts driving control for photographing on the image pickup device 11, and proceeds to step S8. In step S8, the CPU 15 finishes driving control on the image pickup device 11 when the data accumulation time of the image pickup device 11 that functions as an image obtaining unit reaches the time corresponding to the shutter speed. Then, the CPU 15 proceeds to step S9.

In step S9, the CPU 15 causes the image processing circuit 12 to perform predetermined image processing on image data, and proceeds to step S10. The image processing circuit 12 performs predetermined image processing (such as color interpolation, tone conversion, edge enhancement, and white balance control), on each of a shot image (k) captured in response to the ON operation of the full-press switch SW2, a live view image (k-1) captured immediately before the shot image, and a live view image (k-2) captured two frames before the shot image.

In step S10 to be executed after the image processing, the CPU 15 causes the image processing circuit 12 to perform a predetermined filtering operation on the image data, and proceeds to step S11. The image processing circuit 12 performs low-pass filtering for removing signal components of a given frequency or higher, on the live view image (k-1) and the live view image (k-2), out of the image data stored in the SDRAM 16. As a result, so-called “blurring” is applied to the live view image (k-1) and the live view image (k-2).

In step S11 to be executed after the burring operation, the CPU 15 causes the compressing/expanding circuit 17 to perform a compressing operation on the image data, and proceeds to step S12. The compressing/expanding circuit 17 performs JPEG compression on the shot image (k), live view image (k-1), and the live view image (k-2), out of the image data subjected to image processing and stored in the SDRAM 16.

In step S12 to be executed after the image compression, the CPU 15 performs a process of generating and recording an image file for effect reproduction, and proceeds to step S13. More specifically, the images which have been subjected to JPEG compression are stored in an image file in the motion JPEG format, and the image file is recorded onto the recording medium 40. Thus, the shot image (k), live view image (k-1) and the live view image (k-2) are associated with one another, and are recorded as a single image file. The CPU 15 finishes driving control on the image pickup device 11 in step S13, and completes the process of FIG. 3.

### Effect Reproduction

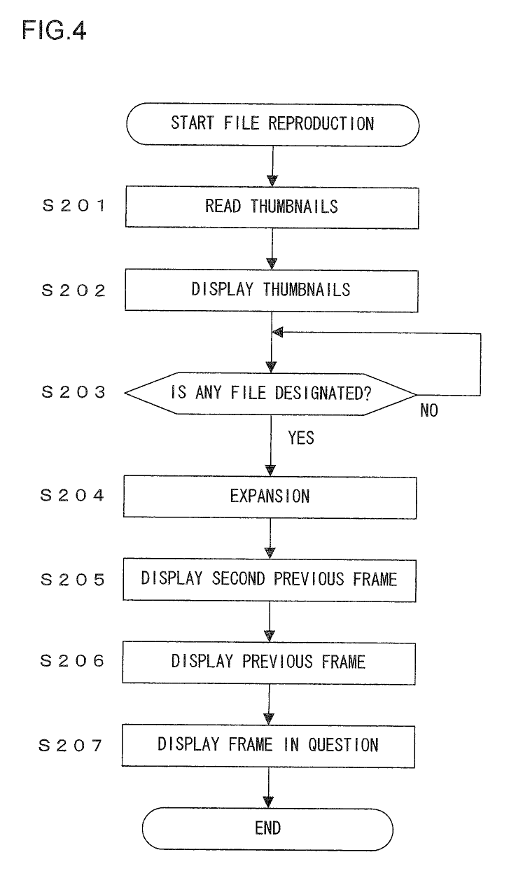

The PC 100 into which a file reproduction program is loaded operates as a file reproducing device when executing the file reproduction program. FIG. 4 is a flowchart explaining the flow of an effect reproduction process performed by the CPU of the PC 100. In step S201 of FIG. 4, the CPU reads thumbnail images from the respective image files for effect reproduction which are recorded in a storage device of the PC 100, and proceeds to step S202. Here, the thumbnail images corresponding to the shot images (k) as described above are read. The CPU may read thumbnail images not only from the image files for effect reproduction which are recorded in the storage device of the PC 100, but also from image files for effect reproduction which are recorded on a recording medium installed in the electronic camera 1 connected to the PC 100 as shown in FIG. 1.

In step S202, the CPU displays the thumbnail images arranged in the form of a list on a monitor of the PC 100, and proceeds to step S203. In step S203, the CPU determines whether an image file to be reproduced and displayed has been designated. If the CPU receives a command of selection of a certain image file according to an operation signal from a keyboard, or the like, it makes an affirmative decision in step S203, and proceeds to step S204. If the CPU receives no command of selection of image file, it makes a negative decision in step S203, and repeats the determining operation.

In step S204, the CPU reads the designated image file from within the storage device, and performs an expanding operation on the JPEG compression code. Then, the CPU proceeds to step S205. Thus, the shot image (k), live view image (k-1) and the live view image (k-2) within the image file are respectively subjected to expanding operations.

In step S205, the CPU displays a reproduced image represented by the image data of the second previous frame (corresponding to the live view image (k-2)) on the monitor of the PC 100, and proceeds to step S206. In step S206, the CPU displays a reproduced image represented by the image data of the previous frame (corresponding to the live view image (k-1)) on the monitor of the PC 100, and proceeds to step S207.

In step S207, the CPU displays a reproduced image represented by the image data of the frame in question (corresponding to the shot image (k)) on the monitor of the PC 100, and completes the process of FIG. 4. Through the display operations of steps S205 to S207, the display on the monitor screen switches in the order of the live view image (k-2), live view image (k-1), and the shot image (k). The frame rate at which the display switches from one frame to another may not be the same as the frame rate at the time of photo shooting (30 frames/sec. in this embodiment), but is set to be faster (i.e., greater) than at least 10 frames/sec.

The embodiment as described above provides the following effects.

(1) A still image file is generated in which a shot image (k) captured according to a photo-shooting command, a live view image (k-1) that is captured at an earlier point in time than the shot image (k) and contains at least a common main subject with the shot image (k), and a live view image (k-2) that is captured at an earlier point in time than the live view image (k-1) and contains at least the main subject are associated or related with one another. Thus, the still image file, when reproduced, suggests past movement of the subject shot and included in the still image (k), to an observer, and helps the observer understand the scene.

(2) The live view image (k-1) and the live view image (k-2) are used as images captured at earlier points in time than the shot image (k). Since the live view images have a lower resolution than the main image (shot image), the data size of the still image file as a whole can be made compact as compared with the case where the entire file consists of main images.

(3) Blurring is applied to main subject regions of the live view image (k-1) and the live view image (k-2); therefore, the past movement of the main subject is suggested or indicated by a reduced degree (namely, is made no more noticeable than necessary).

### MODIFIED EXAMPLE 1

In the filtering operation of step S10, the degree of “blurring” applied to the live view image (k-2) may be made larger than the degree of “blurring” applied to the live view image (k-1). More specifically, the cut-off frequency of low-pass filtering effected on the live view image (k-2) may be set to be lower than the cut-off frequency of low-pass filtering effected on the live view image (k-1).

### MODIFIED EXAMPLE 2

Thumbnail-size images may be created, based on an image obtained by performing filtering on the live view image (k-1) and an image obtained by performing filtering on the live view image (k-2), respectively, and these thumbnail images may be stored in a thumbnail data region within the image file of the shot image (k). In this manner, the image file for effect reproduction can be contained within the data size of one normal JPEG file.

### MODIFIED EXAMPLE 3

Data of an image obtained by performing filtering on the live view image (k-1) and an image obtained by performing filtering on the live view image (k-2) may be stored in a region of a link provided to the image file of the shot image (k).

### MODIFIED EXAMPLE 4

### Generation of File for Effect Reproduction by PC

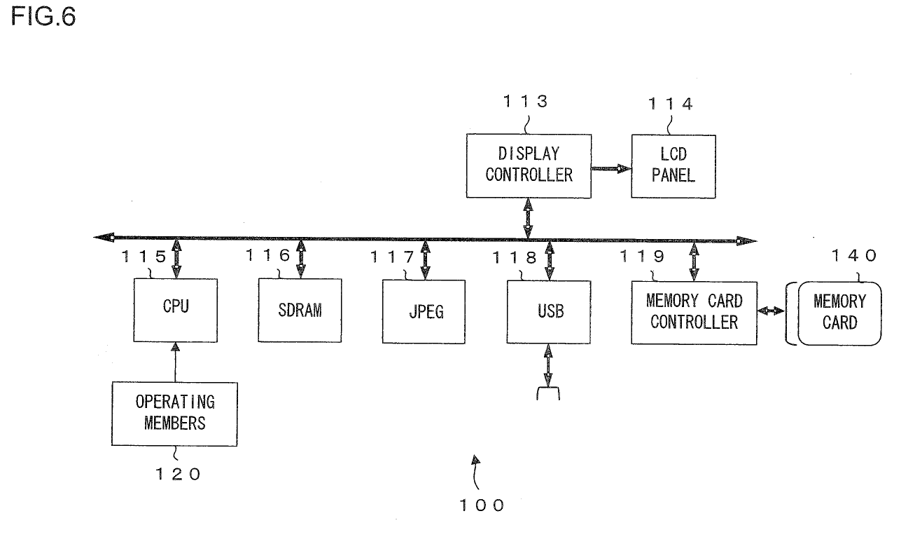

The file for effect reproduction may be generated by the PC 100 that executes a file generation program, rather than the electronic camera 1. FIG. 6 is a block diagram explaining the construction of a principal part of the PC 100. The PC 100 mainly includes a display controller 113, LCD panel (monitor) 114, CPU 115, SDRAM 116, compressing/expanding circuit 117, USB controller 118, memory card controller 119, and operating members (such as a keyboard and a mouse) 120. A recording medium 140 may be inserted into and removed from the PC 100 as desired.

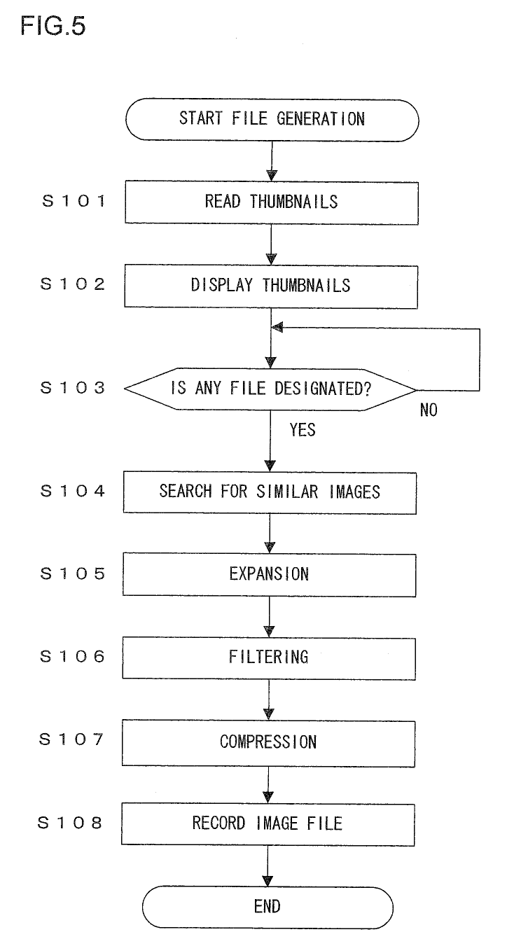

The PC 100 into which the file generation program is loaded operates as a file generating device when executing the file generation program. FIG. 5 is a flowchart explaining the flow of an effect reproduction file generating process performed by the CPU 115 of the PC 100.

In step S101 of FIG. 5, the CPU 115 reads thumbnail images from ordinary image files that are recorded within a storage device of the PC 100 or on the recording medium 140 and are not adapted for effect reproduction, and proceeds to step S102. The CPU 115 may read thumbnail images not only from the image files recorded within the storage device of the PC 100, but also from image files recorded on the recording medium 40 installed in the electronic camera 1 connected to the PC 100 as shown in FIG. 1.

In step S102, the CPU 155 causes the thumbnail images to be arranged and displayed on the monitor of the PC 100, and proceeds to step S103. In step S103, the CPU 115 determines whether any image file is designated as one for which an image file for effect reproduction is to be created, according to a command entered via the operating members 120. If the CPU 115 receives a command of selection of a certain image file in the form of an operation signal from, for example, the keyboard 120, the CPU 115 makes an affirmative decision in step S103, and proceeds to step S104. If the CPU 115 receives no command of selection of image file, it makes a negative decision in step S103, and repeats the above-described determining operation.

In step S104, the CPU 115 searches the thumbnail images displayed in list form on the monitor 114, for thumbnail images similar to the selected and designated thumbnail image. The CPU 115 selects a predetermined number of (two in this embodiment) images that substantially matches the designated image in terms of the date and time of shooting and shooting conditions (such as a focal length, exposure condition, and other conditions at the time of shooting), with reference to tag information of the image files. The CPU 115 then proceeds to step S105. It is to be noted that the image files recorded in the storage device of the PC 100 or on the recording medium 140 include image files captured in a continuous shooting mode.

In step S105, the CPU 115 reads the image file designated in step S103 and the image files selected in step S104, from within the storage device, and performs expanding operations on the JPEG compression code recorded in the read image files. Then, the CPU 115 proceeds to step S106. Thus, an image (m), an image (m-1) and an image (m-2) in the image files are respectively subjected to the expanding operations. In this connection, the image expanded from the image file designated in step S103 is denoted as image (m), and one of the images expanded from the image files selected in step S104, which has the earlier or older date and time of shooting, is denoted as image (m-2), while the other image having the later date and time of shooting is denoted as image (m-1). In this case, the order of shooting from the earliest one to the latest one is the image (m-2), image (m-1) and the image (m).

In step S106, the CPU 115 performs a predetermined filtering operation on data of each image, and proceeds to step S107. More specifically, the CPU 115 performs low-pass filtering for removing signal components of a given frequency or higher, on the image (m-1) and the image (m-2). As a result, so-called “blurring” is applied to the image (m-1) and the image (m-2).

In step S107 to be executed after the blurring operation, the CPU 115 performs a compressing operation on the image data, and proceeds to step S108. As a result, the image (m-1) and the image (m-2) are respectively subjected to JPEG compression. In the meantime, it is not necessary to compress the image (m), since JPEG compression code for the image (m) already exists.

In step S108, the CPU 115 records an image file in which the JPEG compression images are stored in a motion JPEG format as described above, within the storage device of the PC 100 or on the memory card 140. As a result, the image (m), image (m-1) and image (m-2) are associated with one another, and are recorded as a single image file. It is also possible to create and store a management file containing information for associating the image (m), image (m-1) and image (m-2) with one another, aside from the respective files of the image (m), image (m-1) and image (m-2). The information for associating the images with one another includes the destination(s) to which the image (m), image (m-1) and the image (m-2) are saved, and the order of reproduction of the image (m), image (m-1) and the image (m-2).

In the example as described above, the PC 100 into which the LCD panel 114 and the operating members 120, etc. are integrated as shown in FIG. 6 operates as a file generating device. However, the construction of the PC 100 is not limited to this. Namely, the LCD panel 114 and the operating members 120, etc. may be omitted provided that the PC 100 includes an image obtaining unit and a control unit, and is able to perform the file generating process as shown in FIG. 5.

### MODIFIED EXAMPLE 5

The electronic camera 1 may be arranged to perform effect reproduction, instead of implementing effect reproduction on the PC 100. In this case, the electronic camera 1 is operable in a selected one of a normal reproduction mode and an effect reproduction mode. In the normal reproduction mode, image data designated with the operating members 20 is read from the recording medium 40, for example, so that a reproduced image represented by the image data is displayed on the LCD panel (reference number 14 in FIG. 2).

In the effect reproduction mode, image data (an image file for effect reproduction) designated with the operating members 20 is read from the recording medium 40, for example, so that reproduced images are sequentially displayed like animation on the LCD panel (reference numeral 14 in FIG. 2). As described above, reproduced images captured before a shooting command is issued are displayed in sequence according to motion JPEG and then the reproduced image thus designated is displayed.

### MODIFIED EXAMPLE 6

In the effect reproduction, regions of the image (m-1) and the image (m-2) where changes between the frames are smaller than a predetermined amount may be blacked out. For example, a region of the image (m-1) in which the amount of change between the frames of the image (m-1) and the image (m) is smaller than a predetermined value is replaced by black data. Also, a region of the image (m-2) in which the amount of change between the frames of the image (m-2) and the image (m-1) is smaller than the predetermined value is replaced by black data. If the file for effect reproduction is reproduced in this manner, it is possible to suggest the movement of a main subject to the observer, without showing the background that excludes the main subject.

The above-mentioned background region may also be replaced by a single-color image having another color, rather than being blacked out.

According to the embodiment of the invention as described above, only the length of time equivalent to the time required to view a still picture is spent for deepening the observer's understanding of the scene of the still picture.

The above-described embodiments are examples, and various modifications can be made without departing from the scope of the invention.

What is claimed is:

1. An image file generating device that generates a still image file in which a first frame image, a second frame image and a third frame image are associated with one another, wherein:
the first frame image is obtained according to a command;
the second frame image is an image of an earlier point in time than the first frame image, the second frame image containing at least a common main subject with the first frame image; and
the third frame image is an image of an earlier point in time than the second frame image, the third frame image containing at least the main subject.

2. An image file generating device according to claim 1, wherein:
the main subject is a moving subject.

3. An image file generating device according to claim 1, wherein:
the second frame image and the third frame image have a lower resolution than the first frame image.

4. An image file generating device according to claim 1, wherein:
blurring is applied to main subject regions of the second frame image and the third frame image which contain the main subject.

5. An image file generating device according to claim 1, wherein:
background regions of the second frame image and the third frame image which exclude main subject regions containing the main subject are replaced by a single-color image.

6. An image reproducing device that reproduces a still image file in which a first frame image to be reproduced, a second frame image that is an image of an earlier point in time than the first frame image and contains at least a common main subject with the first frame image, and a third frame image that is an image of an earlier point in time than the second frame image and contains at least the main subject are associated with one another, wherein:
the third frame image is displayed on a display device according to a reproduction command;
the second frame image is displayed on the display device so as to replace the third frame image, when a predetermined time elapses after display of the third frame image;
the first frame image is displayed on the display device so as to replace the second frame image, when a predetermined time elapses after display of the second frame image; and
the displayed first frame image is kept displayed.

7. An image reproducing device according to claim 6, wherein:
the main subject is a moving subject.

8. An image reproducing device according to claim 6, wherein:
the second frame image and the third frame image have a lower resolution than the first frame image.

9. An image reproducing device according to claim 6, wherein:
blurring is applied to main subject regions of the second frame image and the third frame image which contain the main subject.

10. An image reproducing device according to claim 6, wherein:
background regions of the second frame image and the third frame image which exclude main subject regions containing the main subject are replaced by a single-color image.

11. A file generating device, comprising:
an image obtaining unit that obtains a first frame image, a second frame image and a third frame image; and
a control unit that generates a file in which the first frame image, the second frame image and the third frame image are associated with one another, wherein:
the first frame image is obtained according to a command;
the second frame image is an image of an earlier point in time than the first frame image, and contains at least a common main subject with the first frame image; and
the third frame image is an image of an earlier point in time than the second frame image, and contains at least the main subject.

12. A file generating device according to claim 11, wherein:
the control unit creates a single still image file in which the first frame image, the second frame image and the third frame image are stored, as the file.

13. A file generating device according to claim 11, wherein:
the control unit creates a management file containing information for associating the first frame image, the second frame image and the third frame image with one another, as the file.
